(19) United States
(12) Patent Application Publication
(10) Pub. No.: US 2026/0188754 A1
(43) Pub. Date: Jul. 2, 2026

(54) SEMI-SOLID ELECTROLYTE MEMBRANE FOR LITHIUM SECONDARY BATTERY, METHOD OF MANUFACTURING SAME, AND LITHIUM SECONDARY BATTERY WITH THE SEMI-SOLID ELECTROLYTE MEMBRANE

(71) Applicant: The Industry & Academic Cooperation in Chungnam National University (IAC), Daejeon (KR)

(72) Inventors: Minh Hai Nguyen, Daejeon (KR); Sang Baek Park, Daejeon (KR); Sang Mun Jeong, Sejong-Si (KR)

(73) Assignee: The Industry & Academic Cooperation in Chungnam National University (IAC), Daejeon (KR)

(21) Appl. No.: 19/272,494

(22) Filed: Jul. 17, 2025

(30) Foreign Application Priority Data
Dec. 26, 2024 (KR) 10-2024-0197299

(51) Int. Cl. H01M 10/0585; H01M 4/02; H01M 4/38; H01M 10/0525; H01M 10/0569

(52) U.S. Cl. CPC H01M 10/0585; H01M 4/382; H01M 10/0525; H01M 10/0569; H01M 2004/027; H01M 2300/0028

(57) ABSTRACT

Disclosed are a semi-solid electrolyte membrane for a lithium secondary battery, a method of manufacturing the same, and a lithium secondary battery with the semi-solid electrolyte membrane, in which the semi-solid electrolyte membrane includes a binary MOF having different pore structures and a liquid electrolyte, thus exhibiting high ionic conductivity and stability.

### CROSS-REFERENCE TO RELATED APPLICATION

This application claims, under 35 U.S.C. § 119 (a), the benefit of priority from Korean Patent Application No. 10-2024-0197299, filed on Dec. 26, 2024, the entire contents of which are incorporated herein by reference.

### BACKGROUND

### (a) Technical Field

The present disclosure relates to a semi-solid electrolyte membrane for a lithium secondary battery, a method of manufacturing the same, and a lithium secondary battery with the semi-solid electrolyte membrane.

### (b) Background Art

Lithium secondary batteries have to satisfy certain standards, including long lifespan, fast charging, high safety levels, stable cycling performance, etc. In most currently-commercialized lithium secondary batteries, graphite is used as a cathode material, but has low volumetric capacity and specific capacity. In contrast, lithium (Li) metal has emerged as a promising alternative for increasing the energy density of lithium secondary batteries due to low electrochemical potential, high theoretical capacity, and high volumetric capacity. However, lithium metal still faces several important challenges for commercialization, including safety concerns, short cycle life, low Coulombic efficiency (CE), volume expansion due to side reaction and/or lithium dendrite growth, etc.

To solve this problem, attempts have been made to replace liquid electrolytes with solid electrolytes. Solid electrolytes have no problems such as leakage and flammability, serve to stabilize the interfacial contact between lithium metal and an electrolyte, have excellent thermal and electrochemical stability, and are able to prevent problems caused by decomposition and volatilization of the electrolyte. However, since the electrolyte layer including the solid electrolyte is thick, the energy density of the battery is low, and there are negative effects in terms of interfacial contact with the electrode, ionic conductivity, brittleness, limited flexibility, etc.

### SUMMARY OF THE DISCLOSURE

The present disclosure has been made keeping in mind the problems encountered in the related art, and an aspect of the present disclosure is to provide a semi-solid electrolyte membrane having excellent interfacial contact between an electrode and an electrolyte and excellent thermal and electrochemical stability, and a method of manufacturing the same.

Another aspect of the present disclosure is to provide a semi-solid electrolyte membrane having excellent lithium ion conductivity and a method of manufacturing the same.

The aspects of the present disclosure are not limited to the foregoing. The aspects of the present disclosure will be able to be clearly understood through the following description and to be realized by the means described in the claims and combinations thereof.

An aspect of the present disclosure provides a semi-solid electrolyte membrane for a lithium secondary battery, including a porous metal-organic framework (MOF) and a liquid electrolyte containing a lithium salt and a non-aqueous organic solvent, in which the liquid electrolyte is contained in pores in the metal-organic framework.

In one embodiment, the metal-organic framework may include any one selected from the group consisting of HKUST-1, ZIF-8, Cu/Zn MOF, and combinations thereof.

Specifically, the HKUST-1 may include any one selected from the group consisting of Oct HKUST-1, Cubo HKUST-1, Cube HKUST-1, and combinations thereof.

In one embodiment, the metal-organic framework may include a first MOF and a second MOF having different pore structures.

Specifically, the first MOF may have a pore structure including sub-nano pores, and the second MOF may have a pore structure including ultra sub-nano pores.

In one embodiment, the first MOF may include any one selected from the group consisting of Oct HKUST-1, Cubo HKUST-1, Cube HKUST-1, and combinations thereof.

In one embodiment, the second MOF may include any one selected from the group consisting of ZIF-8, Cu/Zn MOF, and combinations thereof.

Preferably, the first MOF includes Cubo HKUST-1, and the second MOF includes Cu/Zn MOF.

In one embodiment, a weight ratio of the first MOF to the second MOF may be 1:0.5 to 1:2.

In one embodiment, the first MOF may include a large lithium ion channel, and the second MOF may include a small lithium ion channel.

In one embodiment, the lithium salt may include lithium bis(trifluoromethanesulfonyl)imide (LiTFSI), and the non-aqueous organic solvent may include propylene carbonate (PC).

In one embodiment, the semi-solid electrolyte membrane may further include a binder.

In one embodiment, a weight ratio of the metal-organic framework to the binder may be 3:1 to 5:1.

Another aspect of the present disclosure provides a method of manufacturing a semi-solid electrolyte membrane for a lithium secondary battery, including preparing a slurry including a porous metal-organic framework (MOF) and a binder, manufacturing a MOF film by applying the slurry onto a substrate followed by drying, manufacturing a MOF membrane by separating the MOF film from the substrate followed by pressing, and performing electrochemical activation in which a liquid electrolyte is located in pores in the MOF membrane.

In one embodiment, the metal-organic framework may include any one selected from the group consisting of HKUST-1, ZIF-8, Cu/Zn MOF, and combinations thereof.

In one embodiment, the metal-organic framework may include a first MOF and a second MOF having different pore structures.

Specifically, the first MOF may have a pore structure including sub-nano pores, and the second MOF may have a pore structure including ultra sub-nano pores.

In one embodiment, the first MOF may include any one selected from the group consisting of Oct HKUST-1, Cubo HKUST-1, Cube HKUST-1, and combinations thereof.

In one embodiment, the second MOF may include any one selected from the group consisting of ZIF-8, Cu/Zn MOF, and combinations thereof.

Preferably, the first MOF includes Cubo HKUST-1, and the second MOF includes Cu/Zn MOF.

In one embodiment, a weight ratio of the first MOF to the second MOF may be 1:0.5 to 1:2.

In one embodiment, a weight ratio of the metal-organic framework to the binder may be 3:1 to 5:1.

In one embodiment, the liquid electrolyte may include a lithium salt and a non-aqueous organic solvent, the lithium salt may include lithium bis(trifluoromethanesulfonyl)imide (LiTFSI), and the non-aqueous organic solvent may include propylene carbonate (PC).

In one embodiment, performing the electrochemical activation may include degassing the MOF membrane, manufacturing a lithium symmetric cell using the MOF membrane and the liquid electrolyte as an electrolyte membrane, activating the MOF membrane by driving the lithium symmetric cell, and separating an activated MOF membrane from the lithium symmetric cell.

Still another aspect of the present disclosure provides a lithium secondary battery, including an anode current collector, an anode active material layer located on the anode current collector, the semi-solid electrolyte membrane described above, a cathode active material layer located on the semi-solid electrolyte membrane, and a cathode current collector located on the cathode active material layer.

In one embodiment, the anode active material layer may include lithium metal.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows a lithium secondary battery with a semi-solid electrolyte membrane according to the present disclosure;

FIG. 2 shows the structure of the semi-solid electrolyte membrane according to an embodiment of the present disclosure;

FIG. 3 shows types and pore structures of metal-organic frameworks according to the present disclosure;

FIG. 4A shows a lithium-ion conduction mechanism within a large lithium-ion channel in the semi-solid electrolyte membrane according to the present disclosure;

FIG. 4B shows a lithium-ion conduction mechanism within a small lithium-ion channel in the semi-solid electrolyte membrane according to the present disclosure;

FIG. 5 shows the structure of a lithium symmetric cell for electrochemical activation;

FIG. 6A shows scanning electron microscope (SEM) image of MOFs according to Preparation Example 1;

FIG. 6B shows scanning electron microscope (SEM) image of MOFs according to Preparation Example 2;

FIG. 6C shows scanning electron microscope (SEM) image of MOFs according to Preparation Example 3;

FIG. 6D shows scanning electron microscope (SEM) image of MOFs according to Preparation Example 4;

FIG. 6E shows scanning electron microscope (SEM) image of MOFs according to Preparation Example 5;

FIG. 6F shows results of comparing XRD patterns of Preparation Examples 1 to 5 with patterns of conventionally known ZIF-8 and HKUST-1;

FIG. 7 shows nitrogen adsorption/desorption isotherms and pore distributions of MOFs according to Preparation Example 1;

FIG. 8 shows nitrogen adsorption/desorption isotherms and pore distributions of MOFs according to Preparation Example 2;

FIG. 9 shows nitrogen adsorption/desorption isotherms and pore distributions of MOFs according to Preparation Example 3;

FIG. 10 shows nitrogen adsorption/desorption isotherms and pore distributions of MOFs according to Preparation Example 4;

FIG. 11 shows nitrogen adsorption/desorption isotherms and pore distributions of MOFs according to Preparation Example 5;

FIGS. 12 to 16 show results of comparing the XRD patterns of MOFs according to Preparation Examples 1 to 5 and MOFs after activation;

FIG. 17 shows results of thermogravimetric analysis (TGA) for a semi-solid electrolyte membrane according to Example 1, the MOF used in the manufacturing process thereof, and the liquid electrolyte;

FIG. 18 shows results of thermogravimetric analysis (TGA) for a semi-solid electrolyte membrane according to Example 2, the MOF used in the manufacturing process thereof, and the liquid electrolyte;

FIG. 19 shows results of thermogravimetric analysis (TGA) for a semi-solid electrolyte membrane according to Example 3, the MOF used in the manufacturing process thereof, and the liquid electrolyte;

FIG. 20 shows results of thermogravimetric analysis (TGA) for a semi-solid electrolyte membrane according to Example 4, the MOF used in the manufacturing process thereof, and the liquid electrolyte;

FIG. 21 shows results of thermogravimetric analysis (TGA) for a semi-solid electrolyte membrane according to Example 5, the MOF used in the manufacturing process thereof, and the liquid electrolyte;

FIG. 22 shows linear sweep voltammetry (LSV) curves of batteries with the semi-solid electrolyte membranes according to Examples 1 to 5 and Comparative Example 1;

FIG. 23 shows Nyquist plots of the batteries with the semi-solid electrolyte membranes according to Examples 1 to 5;

FIG. 24 shows results of FT-IR of the MOF according to Preparation Example 2 before and after electrochemical activation;

FIG. 25 shows results of FT-IR of the MOF according to Preparation Example 5 before and after electrochemical activation;

FIG. 26 shows results of Raman spectrum analysis for a pure LIFTSI lithium salt and the semi-solid electrolyte membranes according to Examples 2 and 5;

FIG. 27 shows 7Li solid-state MAS (magic angle spinning) NMR spectra for the pure LIFTSI lithium salt and the semi-solid electrolyte membranes according to Examples 2 and 5;

FIG. 28 shows SEM results of a semi-solid electrolyte membrane according to Example 6;

FIG. 29 shows LSV curves of semi-solid electrolyte membranes according to Example 6 and Comparative Examples 1 and 4;

FIG. 30 shows a Nyquist curve of the semi-solid electrolyte membrane according to Example 6;

FIG. 31 shows results of thermogravimetric analysis for the liquid electrolyte and the semi-solid electrolyte membranes according to Examples 2, 5, and 6;

FIG. 32 shows results of combustion and heat shrinkage of the semi-solid electrolyte membranes according to Comparative Example 1 and Example 6;

FIG. 33 shows a charge/discharge curve of a full cell with the semi-solid electrolyte membrane according to Example 6 during charging and discharging at a high temperature;

FIG. 34 shows a galvanostatic charge-discharge (GCD) curve of a full cell with the semi-solid electrolyte membrane according to Comparative Example 1 during charging and discharging at a high temperature;

FIG. 35 shows a galvanostatic charge-discharge (GCD) curve of a full cell with the semi-solid electrolyte membrane according to Example 6 during charging and discharging at a low temperature; and

FIG. 36 shows results of measurement of the Coulombic efficiency of the full cell with the semi-solid electrolyte membrane according to Example 6.

### DETAILED DESCRIPTION

The above and other aspects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

Furthermore, unless specifically stated otherwise, the term “about” as used herein may be understood within a range of error that is typical in the art (e.g., within 2 standard deviations of the mean). “About” may be understood as within 10%, 9%, 8%, 7%, 6%, 5%, 4%, 3%, 2%, 1%, 0.5%, 0.1%, 0.05%, or 0.01% of the stated value.

In addition, “vehicle” or “automobile” or other similar terms used herein are understood to include general automobiles such as sport utility vehicles (SUVs), buses, trucks, various commercial vehicles, etc., and transportation means such as trains, ships, and aircraft, and also include hybrid vehicles, electric vehicles, plug-in hybrid electric vehicles, hydrogen-powered vehicles, and other alternative fuel vehicles (e.g., fuel derived from resources other than petroleum). “Hybrid vehicle” as used herein means a vehicle that has two or more power sources (e.g., a gasoline-powered vehicle and an electric-powered vehicle).

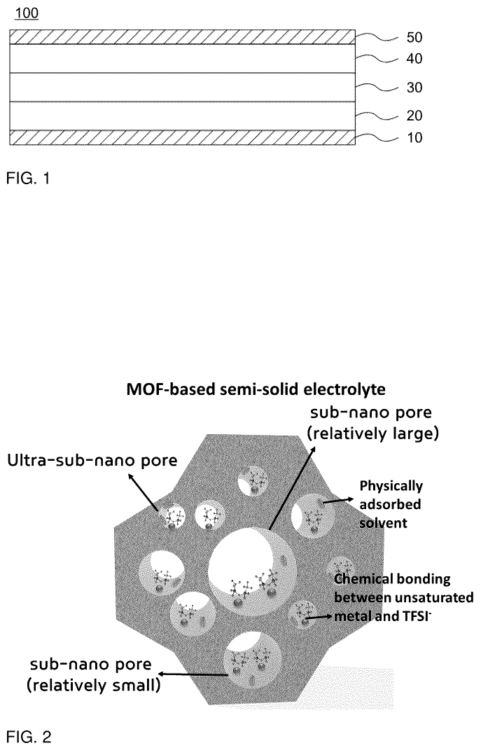

FIG. 1 shows a lithium secondary battery 100 with a semi-solid electrolyte membrane according to the present disclosure. The lithium secondary battery 100 may include an anode current collector 10, an anode active material layer 20 located on the anode current collector 10, a semi-solid electrolyte membrane 30 according to the present disclosure, a cathode active material layer 40 located on the semi-solid electrolyte membrane 30, and a cathode current collector 50 located on the cathode active material layer 40.

The anode current collector 10 may include a plate-shaped substrate having electrical conductivity. The anode current collector 10 may include copper (Cu), nickel (Ni), stainless steel, etc.

The anode current collector 10 may include a high-density metal thin film having a porosity of less than about 1%.

The thickness of the anode current collector 10 is not particularly limited and may be, for example, 1 μm to 20 μm, or 5 μm to 15 μm.

The anode active material layer may include an anode active material capable of intercalation and deintercalation of lithium ions, and may further include a conductive material, a binder, etc. Also, the anode active material layer may include a solid electrolyte to improve lithium ion conductivity.

The anode active material may include a compound capable of reversible intercalation and deintercalation of lithium. For example, the anode active material may include a graphite-based active material, a silicon-based active material, lithium metal, etc., and preferably includes lithium metal.

The type of binder is not particularly limited, and examples thereof may include polyvinylidene fluoride (PVDF), polytetrafluoroethylene (PTFE), polyvinyl alcohol, etc.

The type of conductive material is not particularly limited, and examples thereof may include carbon black, conductive graphite, ethylene black, carbon fiber, graphene, and the like.

The semi-solid electrolyte membrane having lithium ion conductivity may be stacked on the anode active material layer. FIG. 2 shows the structure of the semi-solid electrolyte membrane according to an embodiment of the present disclosure.

The semi-solid electrolyte membrane for a lithium secondary battery according to the present disclosure may include a porous metal-organic framework (MOF) and a liquid electrolyte containing a lithium salt and a non-aqueous organic solvent, in which the liquid electrolyte may be included in pores in the metal-organic framework. As the liquid electrolyte is included in the pores in the metal-organic framework of the semi-solid electrolyte membrane according to the present disclosure, lithium ion channels may be formed. In one embodiment, the liquid electrolyte may be confined within the pores of the metal-organic framework.

The metal-organic framework is a porous material in which a metal ion or metal cluster is connected to an organic ligand and refers to a kind of coordination polymer, and in the present disclosure, the metal-organic framework may include, for example, any one selected from the group consisting of HKUST-1, ZIF-8, Cu/Zn MOF, and combinations thereof. Here, HKUST-1 is also referred to as ZIF-199, and may include any one selected from the group consisting of Oct HKUST-1 having an octahedral structure, Cubo HKUST-1 having a truncated cuboctahedral structure, Cube HKUST-1 having a cubic structure, and combinations thereof, depending on the crystal structure thereof. Also, Cu/Zn MOF refers to copper-doped ZIF-8.

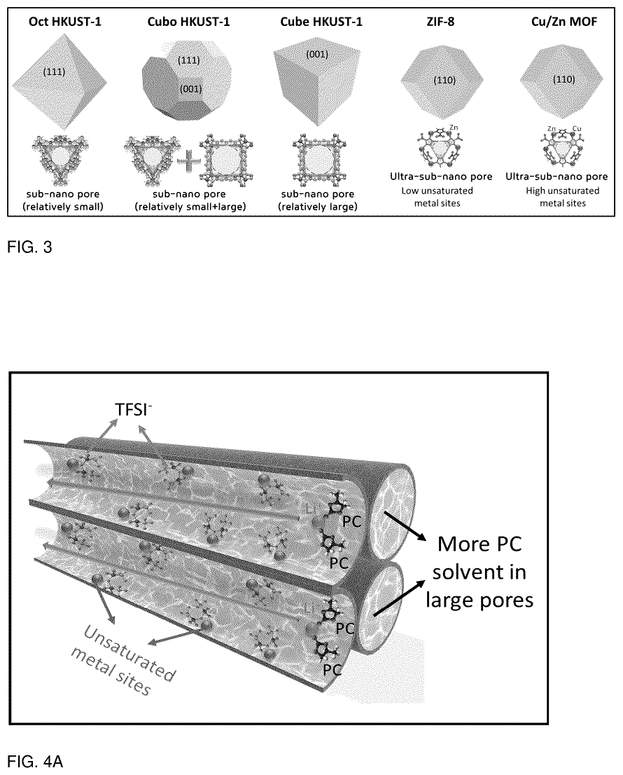

For the types and pore structures of metal-organic frameworks used in the present disclosure, reference may be made to FIG. 3.

In one embodiment, the metal-organic framework may include a first MOF and a second MOF having different pore structures. Specifically, the first MOF may have a pore structure including sub-nano pores, and the second MOF may have a pore structure including ultra sub-nano pores. For reference, the pore sizes used herein are classified into macro pores of greater than 50 nm, meso pores of 2 nm to 50 nm, and micro pores of 2 nm or less, depending on the average pore diameter thereof, and the micro pores may be subclassified into nano pores of 1 nm to 2 nm, sub-nano pores of 0.5 nm to 1 nm, and ultra sub-nano pores of 0.5 nm or less.

In the present disclosure, a binary MOF including a first MOF having a relatively large pore size and a second MOF having a relatively small pore size is used as the metal-organic framework, thereby forming two types of lithium ion conduction channels responsible for conduction by different mechanisms.

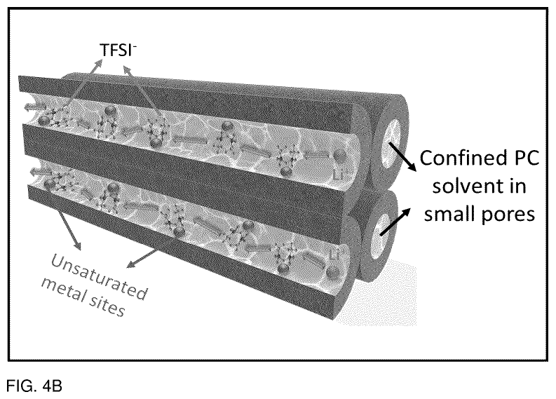

In one embodiment, the first MOF may include large lithium ion channels, and the second MOF may include small lithium ion channels. FIG. 4A and FIG. 4B shows two types of lithium ion conduction modes in the semi-solid electrolyte membrane according to the present disclosure.

Referring to the FIG. 4A, a liquid electrolyte including a lithium salt (e.g., LiTFSI) and an organic solvent (e.g., propylene carbonate) is included in the pores in the first MOF in which relatively large pores are formed. Here, the TFSI radical of the lithium salt tends to interact with the unsaturated metal cation of the first MOF, and the lithium ions may be surrounded by the organic solvent molecules adsorbed in the pores in the first MOF. Accordingly, direct interaction between lithium ions and TFSI-in the large lithium ion channels is hindered. Therefore, during charging/discharging of the battery, the lithium ions may move along with the organic solvent under the influence of the electric field.

On the other hand, referring to the FIG. 4B, the liquid electrolyte including a lithium salt (e.g., LiTFSI) and an organic solvent (e.g., propylene carbonate) is included in the pores in the second MOF in which relatively small pores are formed. However, for the second MOF, unlike the first MOF, only a smaller amount of solvent is included in the pores. Therefore, it becomes difficult for lithium ions to be surrounded by organic solvent molecules adsorbed in the pores in the second MOF, and thus direct interaction between lithium ions and TFSI-occurs in the lithium ion channels. Therefore, during charging/discharging of the battery, the lithium ions may be conducted by a hopping mechanism by repeating attachment to and deattachment from TFSI⁻ at the unsaturated metal site of the second MOF.

In the semi-solid electrolyte membrane according to the present disclosure, the binary MOF including the first MOF containing relatively large pores and the second MOF containing small pores may be introduced, thus simultaneously providing large lithium ion channels and small lithium ion channels having different lithium ion conduction modes, thereby obtaining a semi-solid electrolyte membrane having excellent lithium ion conductivity and stability.

In one embodiment, the first MOF may include any one selected from the group consisting of Oct HKUST-1, Cubo HKUST-1, Cube HKUST-1, and combinations thereof. Also, the second MOF may include any one selected from the group consisting of ZIF-8, Cu/Zn MOF, and combinations thereof. Preferably, the first MOF includes Cubo HKUST-1, and the second MOF includes Cu/Zn MOF.

In one embodiment, the weight ratio of the first MOF to the second MOF may be 1:0.5 to 1:2. Preferably, the weight ratio of the first MOF to the second MOF is about 1:1. When the weight ratio of the first MOF to the second MOF falls within the above numerical range, the effect of introducing the binary MOF may be maximized.

In one embodiment, the lithium salt included in the liquid electrolyte according to the present disclosure is not particularly limited, and examples thereof may include LiCl, LiBr, Lil, LiBF₄, LiClO₄, LiB₁₀Cl₁₀, LiAlCl₄, LiAlO₄, LiPF₆, LiCF₃SO₃, LiCH₃CO₂, LiCF₃CO₂, LiAsF₆, LiSbF₆, LiCH₃SO₃, LiN(SO₂F)₂ (lithium bis(fluorosulfonyl)imide, LiFSI), LiN(SO₂CF₂CF₃)₂ (lithium bis(pentafluoroethanesulfonyl)imide, LiBETI), LiN(SO₂CF₃)₂ (lithium bis(trifluoromethane sulfonyl)imide, LiTFSI), and the like, but preferably, lithium bis(trifluoromethanesulfonyl)imide (LiTFSI) is used.

Also, the non-aqueous organic solvent is not particularly limited so long as it is commonly used in the relevant technical field, and preferably, propylene carbonate (PC) is used.

In one embodiment, the semi-solid electrolyte membrane may further include a binder. The type of binder included in the semi-solid electrolyte membrane is not particularly limited, and examples thereof may include polyvinylidene fluoride (PVDF), polytetrafluoroethylene (PTFE), polyvinyl alcohol, and the like.

In one embodiment, the weight ratio of the metal-organic framework to the binder may be from 3:1 to 5:1, preferably about 4:1. When the weight ratio of the metal-organic framework to the binder falls within the above numerical range, the semi-solid electrolyte membrane may exhibit superior brittleness and flexibility.

A method of manufacturing the semi-solid electrolyte membrane for a lithium secondary battery according to the present disclosure may include preparing a slurry including a porous MOF and a binder, manufacturing a MOF film by applying the slurry onto a substrate followed by drying, manufacturing a MOF membrane by separating the MOF film from the substrate followed by pressing, and performing electrochemical activation in which a liquid electrolyte is located in the pores in the MOF membrane.

The semi-solid electrolyte membrane and components thereof are as described above and thus a description thereof is omitted below. In addition, the method and conditions for application of the slurry, drying, or pressing are not particularly limited, and any method and condition that are widely used in the technical field to which the present disclosure belongs should be interpreted as falling within the scope of the present disclosure.

In one embodiment, electrochemical activation may be performed so that the liquid electrolyte is located in the pores in the MOF membrane. Specifically, performing the electrochemical activation may include degassing the MOF membrane, manufacturing a lithium symmetric cell using the MOF membrane and the liquid electrolyte as an electrolyte membrane, activating the MOF membrane by driving the lithium symmetric cell, and separating the activated MOF membrane from the lithium symmetric cell.

The MOF membrane thus activated includes the liquid electrolyte in pores thereof and may be understood as a semi-solid electrolyte membrane.

A better understanding of the present disclosure may be obtained through the following examples and comparative examples. However, these examples are not to be construed as limiting the technical spirit of the present disclosure.

### Preparation Examples 1 to 3-Oct HKUST-1, Cubo HKUST-1, Cube HKUST-1

In order to prepare HKUST-1 (first MOF) having various crystal structures, a solvothermal method was used with some modifications. Specifically, a copper salt solution was prepared by mixing copper (II) nitrate trihydrate (Cu(NO₃)₂·3H₂O, 99%, Sigma-Aldrich) (0.415 g, 0.68 mmol) and various amounts of lauric acid (99%, Sigma-Aldrich) (9.55 g, 18.90 mmol; 19.23 g, 38 mmol; and 28.75 g, 57.04 mmol) followed by dissolution in 50 ml of 1-butanol (99.9%, Sigma-Aldrich). Also, a linker solution was prepared by dissolving 1,3,5-benzenetricarboxylic acid (95%, Sigma-Aldrich) (0.21 g, 0.38 mmol) in 50 ml of 1-butanol.

The linker solution was added dropwise over 30 minutes to the prepared copper salt solution through self-stirring for 30 minutes. The resulting mixture was stirred continuously for 30 minutes, transferred to a Teflon-lined stainless steel autoclave, and heated at 140° C. for 2 hours.

The heated mixture was centrifuged at a rotation speed of 10,000 rpm for 10 minutes in a fixed-angle rotor to recover particles, which were then washed three times with ethanol (99.9%, Thermo Fisher Scientific) and dried at 90° C. Finally, the powder was heated overnight at 180° C. in a vacuum oven and thus degassed and then stored in a desiccator.

After drying, the synthesized metal-organic frameworks were named Preparation Example 1: Oct HKUST-1 (lauric acid: 9.55 g, 18.90 mmol), Preparation Example 2: Cubo HKUST-1 (lauric acid: 19.23 g, 38 mmol), and Preparation Example 3: Cube HKUST-1 (lauric acid: 28.75 g, 57.04 mmol), depending on the amount of lauric acid used.

### Preparation Example 4-ZIF-8

2.14 g of zinc nitrate hexahydrate (Zn(NO₃)₂·6H₂O, 98%, Sigma-Aldrich) and 4.64 g of 2-methylimidazole (2-MIM, 99%, Sigma-Aldrich) were each dissolved in 50 ml of methanol. Thereafter, the Zn(NO₃)₂·6H₂O methanol solution was added dropwise to the 2-MIM methanol solution and stirred at room temperature for 15 hours.

Thereafter, the slurry containing the dispersed ZIF-8 particles was placed in a centrifuge and centrifuged at 10,000 rpm for 10 minutes to recover the ZIF-8 particles. The recovered ZIF-8 particles were washed three times with methanol (99.8%, DAEJUNG) and then dried overnight at 180° C. under vacuum conditions, yielding a MOF according to Preparation Example 4.

### Preparation Example 5—Cu/Zn MOF (Cu-Doped ZIF-8)

A solution including 0.66 g of Zn(NO₃) 2.6H₂O and 0.54 g of Cu(NO₃)₂·3H₂O (total 1 mmol) dissolved in 50 ml of methanol and a solution including 2.92 g of 2-MIM dissolved in 50 ml of methanol were separately prepared. Then, the 2-MIM methanol solution was added dropwise to the Cu²⁺-Zn²⁺ solution and stirred at room temperature for 2 hours. Then, the slurry containing the dispersed Cu/Zn MOF (Cu-doped ZIF-8) particles was placed in a centrifuge and centrifuged at 10,000 rpm for 10 minutes to recover the Cu/Zn MOF particles. The recovered Cu/Zn MOF particles were washed three times with 30 ml of methanol (99.8%, DAEJUNG) and then dried overnight at 180° C. under vacuum conditions, yielding a MOF according to Preparation Example 5.

### Test Example 1—Morphology and Structure of Synthesized MOF

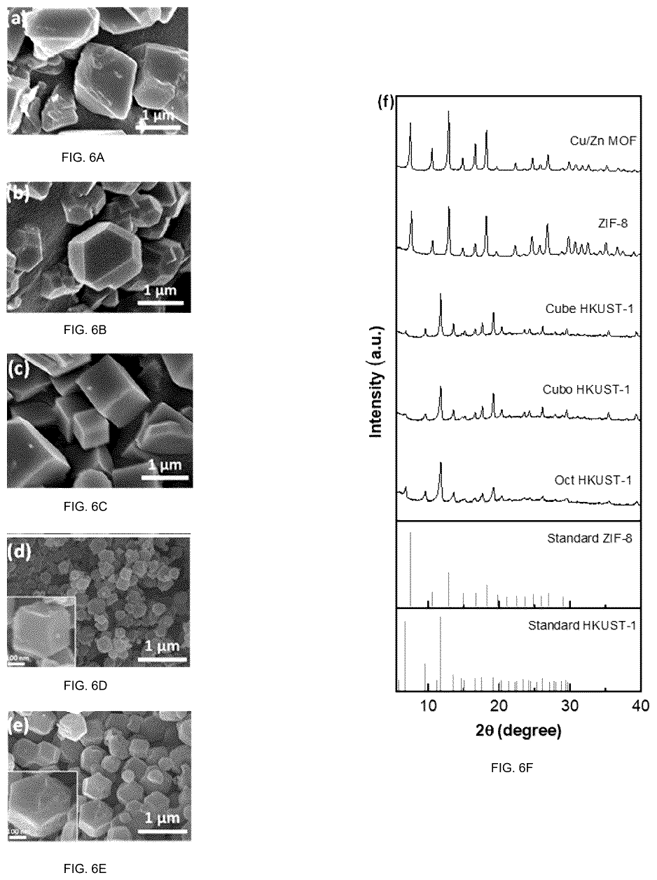

In order to investigate the morphology and crystal structure of the MOFs according to Preparation Examples 1 to 5 synthesized above, the MOFs according to Preparation Examples 1 to 5 were observed using a scanning electron microscope (SEM), and an image of Preparation Example 1 is shown in FIG. 6A, an image of Preparation Examples 2 is shown in FIG. 6B, an image of Preparation Example 3 is shown in FIG. 6C, an image of Preparation Example 4 is shown in FIG. 6D, an image of Preparation Example 5 is shown in FIG. 6E.

The MOFs according to Preparation Examples 1 to 5 were analyzed using XRD, after which the XRD patterns thereof were compared with the patterns of conventionally known ZIF-8 and HKUST-1, and the results are shown in FIG. 6F.

Referring to the results of FIGS. 6A to 6F, as the concentration of lauric acid used in the synthesis of HKUST-1 increased from 18.90 mmol to 57.04 mmol, the crystal morphology of the synthesized HKUST-1 was confirmed to change from an octahedral structure (Oct HKUST-1) to a truncated cuboctahedral structure (Cubo HKUST-1) and finally to a cubic structure (Cube HKUST-1). This is deemed to be because, during the process of synthesizing HKUST-1 by the solvothermal method, lauric acid acted as a growth inhibitor, selectively controlling crystal growth along the {111} or {100} planes. Also, the particle size of the synthesized HKUST-1 was about 1 to 2 μm.

Meanwhile, referring to the results of Preparation Examples 4 and 5, ZIF-8 and Cu/Zn MOF (Cu-doped ZIF-8) having a rhombic dodecahedral structure were successfully synthesized. Also, the particle sizes of the synthesized ZIF-8 and Cu/Zn MOF were about 300 nm to 500 nm.

Moreover, the MOFs synthesized according to Preparation Examples 1 to 5 were confirmed to correspond to the XRD peak patterns of conventionally known HKUST-1 and ZIF-8.

### Test Example 2—Pore Distribution and Surface Area of Synthesized MOF

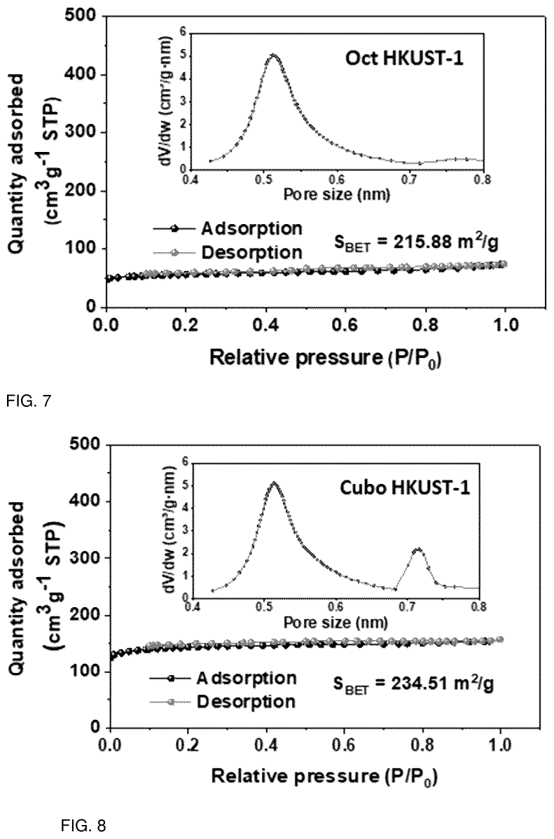

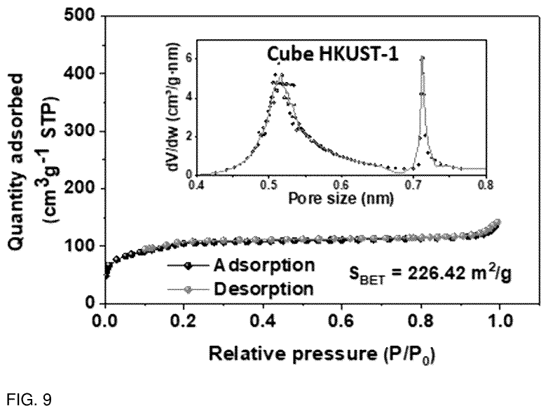

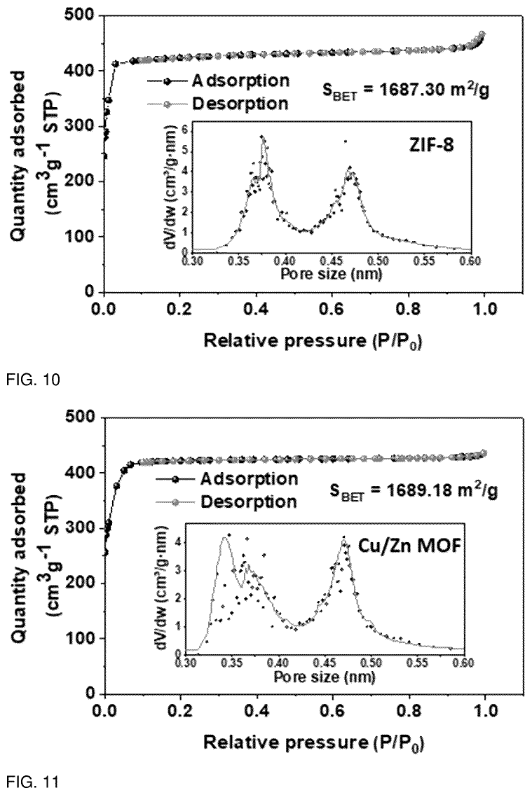

The pore size distribution and BET specific surface area of the MOFs according to Preparation Examples 1 to 5 were analyzed using a known method, and the result of the Preparation Example 1 is shown in FIG. 7, the result of the Preparation Example 2 is shown in FIG. 8, the result of the Preparation Example 3 is shown in FIG. 9, the result of the Preparation Example 4 is shown in FIG. 10, the result of the Preparation Example 5 is shown in FIG. 11. Specifically, FIGS. 7 to 11 show nitrogen adsorption/desorption isotherms and pore distributions of the MOFs according to Preparation Examples 1 to 5, respectively.

Referring to FIGS. 7 to 11, the MOFs according to Preparation Examples 4 and 5 mainly showed ultra sub-nano pores having a size of 0.34 to 0.46 nm, and the MOFs according to Preparation Examples 1 to 3 mainly showed sub-nano pores having a size of 0.52 to 0.72 nm. In addition, the MOFs according to Preparation Examples 4 and 5 had very high specific surface areas (1687.30 to 1689.18 m²/g, 215.88 to 234.51 m²/g) compared to Preparation Examples 1 to 3.

This is deemed to be due to the difference in crystal structure between the MOFs according to Preparation Examples 4 and 5 having a rhombic dodecahedral structure and the MOFs according to Preparation Examples 1 to 3 having Oct, Cubo, and Cube structures. Specifically, the MOFs according to Preparation Examples 4 and 5 had lattice planes such as (110) having a very small window size (about 0.34 nm), whereas the MOFs according to Preparation Examples 1 to 3 had lattice families such as {111} and {001} having larger window sizes (0.46 nm, 0.9 nm).

### Example 1—Activated Oct HKUST-1

The MOF powder synthesized as in Preparation Example 1 was added to acetone (99.5%, SAMCHUN) and then sonicated to afford a homogeneous slurry. Thereafter, a PVDF solution including 7.5 wt % of PVDF as a binder (99.5%, MTI) in N,N-dimethylformamide (DMF, 99.5%, Sigma-Aldrich) as a solvent was prepared, and the PVDF solution was added to the homogeneous slurry to afford a MOF slurry. As such, the weight ratio of MOF to PVDF in the MOF slurry was 4:1. Thereafter, the MOF slurry was stirred at room temperature to remove the organic solvent from the slurry, thereby obtaining MOF ink.

The MOF ink was uniformly cast on aluminum foil using a doctor blade and then dried overnight at 120° C. under vacuum conditions, thus obtaining a MOF film. The MOF film stacked on the aluminum foil was soaked in methanol for several minutes and then the MOF film was separated from the aluminum foil. To increase the density of the separated MOF film, pressing was performed at a pressure of about 200 MPa, thus obtaining a MOF membrane. Thereafter, the MOF membrane was processed into a circle having a diameter of 18 mm and then degassed overnight at 180° C. under vacuum conditions.

Meanwhile, 1 M of a LiTFSI liquid electrolyte was obtained by mixing 1.44 g of lithium bis(trifluoromethanesulfonyl)imide (LiTFSI, 99.9%, Sigma-Aldrich) and 5 ml of propylene carbonate (PC, 99.7%, Sigma-Aldrich) as a solvent.

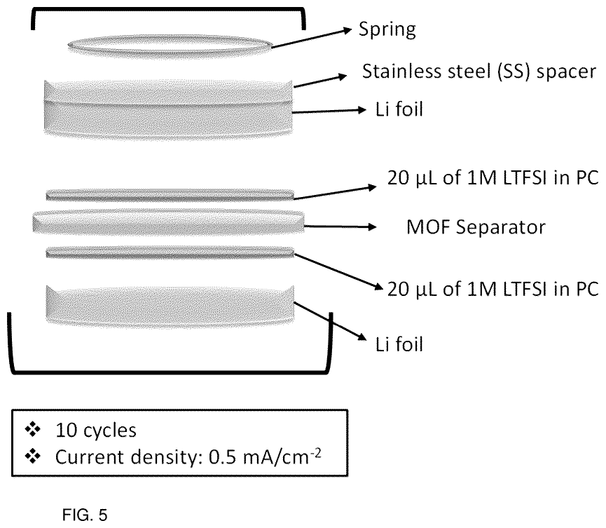

A lithium symmetric cell having the structure as shown in FIG. 5 was prepared using the MOF membrane and the LiTFSI liquid electrolyte as prepared above. Subsequently, the MOF membrane was activated by subjecting the lithium symmetric cell to 10 cycles of charging and discharging at 0.5 mA/cm². Thereafter, the activated MOF membrane was separated from the symmetric cell and the liquid electrolyte remaining on the surface was removed, ultimately obtaining a semi-solid electrolyte membrane according to Example 1.

### Example 2—Activated Cubo HKUST-1

A semi-solid electrolyte membrane according to Example 2 was obtained in the same manner as in Example 1, with the exception that the MOF according to Preparation Example 2 was used, compared to Example 1.

### Example 3—Activated Cube HKUST-1

A semi-solid electrolyte membrane according to Example 3 was obtained in the same manner as in Example 1, with the exception that the MOF according to Preparation Example 3 was used, compared to Example 1.

### Example 4—Activated ZIF-8

A semi-solid electrolyte membrane according to Example 4 was obtained in the same manner as in Example 1, with the exception that the MOF according to Preparation Example 4 was used, compared to Example 1.

### Example 5—Activated Cu/Zn MOF (Cu-Doped ZIF-8)

A semi-solid electrolyte membrane according to Example 5 was obtained in the same manner as in Example 1, with the exception that the MOF according to Preparation Example 5 was used, compared to Example 1.

### Example 6—Activated Cubo HKUST-1@Cu/Zn MOF

A semi-solid electrolyte membrane according to Example 6 was obtained in the same manner as in Example 1, with the exception that the MOF according to Preparation Example 2 and the MOF according to Preparation Example 5 were used in combination in a weight ratio of 1:1, compared to the Example 1.

### Comparative Example 1—Celgard 2400+LE

An electrolyte membrane according to Comparative Example 1 was prepared by impregnating Celgard 2400 as a commercially available porous electrolyte membrane with 1 M of the LiTFSI liquid electrolyte prepared in Example 1.

### Comparative Example 2—Cubo HKUST-1+LE

A semi-solid electrolyte membrane according to Comparative Example 2 was prepared in the same manner as in Example 2, with the exception that a MOF membrane was manufactured using the MOF according to Preparation Example 2 without separate activation and then impregnated with 1 M of the LiTFSI liquid electrolyte.

### Comparative Example 3—Cu/Zn MOF+LE

A semi-solid electrolyte membrane according to Comparative Example 3 was prepared in the same manner as in Example 5, with the exception that a MOF membrane was manufactured using the MOF according to Preparation Example 5 without separate activation and then impregnated with 1 M of the LiTFSI liquid electrolyte.

### Comparative Example 4—Cubo HKUST-1@Cu/Zn MOF+LE

A semi-solid electrolyte membrane according to Comparative Example 4 was prepared in the same manner as in Example 6, with the exception that a MOF membrane was manufactured using a mixed MOF of the MOF according to Preparation Example 2 and the MOF according to Preparation Example 5 in a weight ratio of 1:1 without separate activation and then impregnated with 1 M of the LiTFSI liquid electrolyte.

### Test Example 3—Confirmation of Penetration of Liquid Electrolyte into Pores in MOF

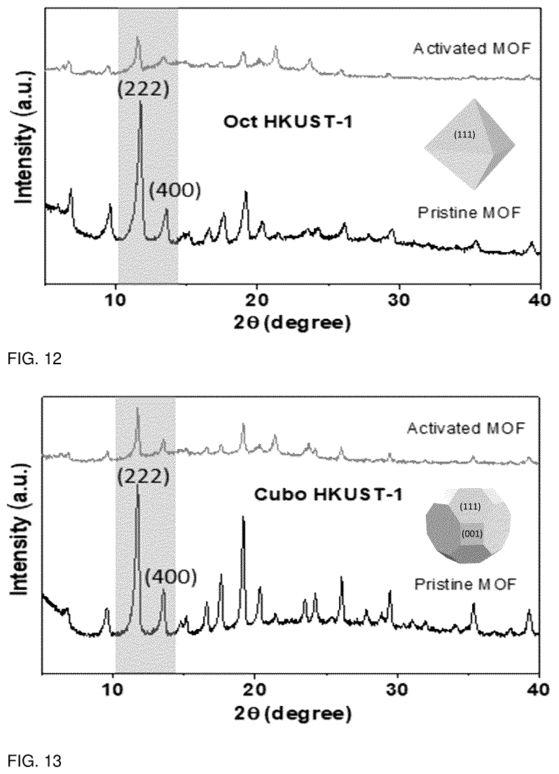

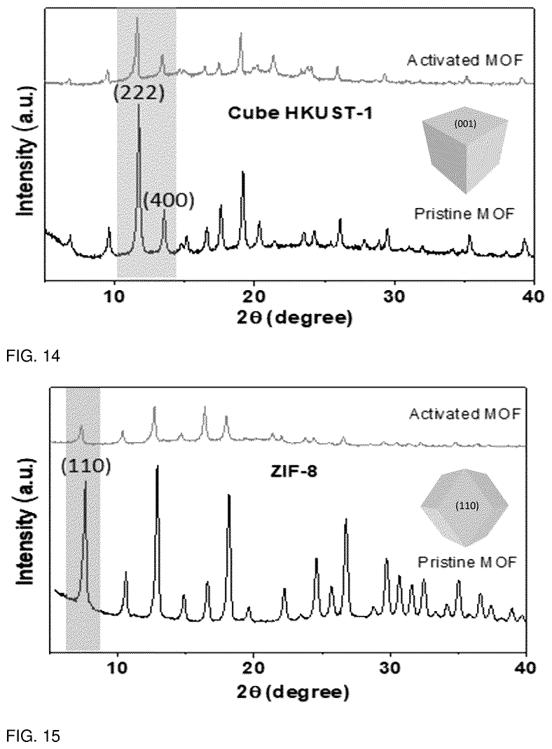

In order to confirm whether the liquid electrolyte properly penetrated the pores in the synthesized MOF by electrochemical activation, the XRD patterns of the MOFs according to Preparation Examples 1 to 5 and the MOFs according to Examples 1 to 5 after activation were compared, and the results are shown in FIGS. 12 to 16.

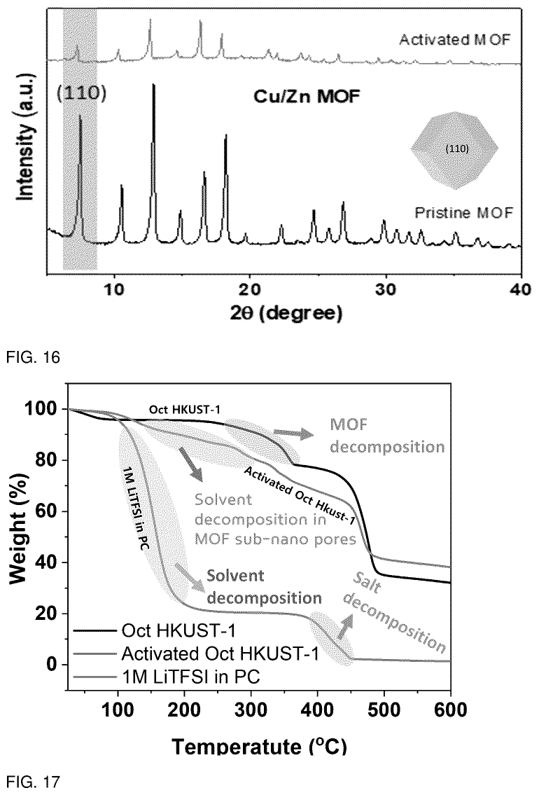

Referring to FIGS. 12 to 14, the peak intensity at the (222) plane and the (400) plane was greatly reduced in the HKUST-1-based MOF, and referring to FIGS. 15 and 16, the peak intensity at the (100) plane was greatly reduced in the ZIF-8-based MOF. This indicates that the liquid electrolyte molecules are confined in the pores in the MOF along characteristic lattice planes.

In addition, to further confirm the effect of the liquid electrolyte on penetrating the pores in the MOF, mass changes of the MOF membrane before electrochemical activation used in the process of manufacturing the semi-solid electrolyte membrane according to each of Examples 2, 5, and 6, the MOF membrane after contact with the liquid electrolyte, and the semi-solid electrolyte membrane after activation were measured, from which the amount of the liquid electrolyte confined in the pores in MOF was then determined. The results are shown in Table 1 below.

TABLE 1

| | Mass | Mass of | Mass of | | Loading |
|---|---|---|---|---|---|
| | of | MOF | semi-solid | Mass | ratio |
| | MOF | membrane | electrolyte | of | of liquid |
| | mem- | after | mem- | liquid | elec- |
| | brane | contact | brane | elec- | trolyte |
| | before | with | after | trolyte | in |
| | acti | liquid | acti- | in pores | pores |
| | vation | electrolyte | vation | (g cm⁻²) | (%) |
| | (g cm⁻²) | (g cm⁻²) | (g cm⁻²) | (D = | (E = |
| Sample | (A) | (B) | (C) | C − B) | 100*D/C) |
| Cubo HKUST-1 | 0.01065 | 0.01318 | 0.01429 | 0.00110 | 7.73 |
| Cu/Zn MOF | 0.00877 | 0.01169 | 0.01351 | 0.00182 | 13.46 |
| Cubo HKUST- | 0.01021 | 0.01623 | 0.01832 | 0.00209 | 11.41 |
| 1@Cu/Zn MOF | | | | | |

As shown in Table 1, the Cu/Zn MOF sample exhibited a liquid electrolyte retention capacity of up to 13.46% by mass, whereas the Cubo HKUST-1 sample exhibited a liquid electrolyte retention capacity of only 7.73%. In addition, the Cubo HKUST-1@Cu/Zn MOF sample using the binary MOF including two MOFs mixed showed a liquid electrolyte retention capacity of up to 11.41%. This is deemed to be because the specific surface area and pore density of Cu/Zn MOF were larger than those of HKUST-1, allowing a larger amount of the liquid electrolyte to be adsorbed and stored in the pores. Also, as is apparent from the data of Table 1, the mass was more greatly increased in all samples after activation than before activation. This indicates that the liquid electrolyte molecules very efficiently penetrate the pores in the MOF by electrochemical activation.

### Test Example 4—Thermal Stability of Semi-Solid Electrolyte Membrane after Activation

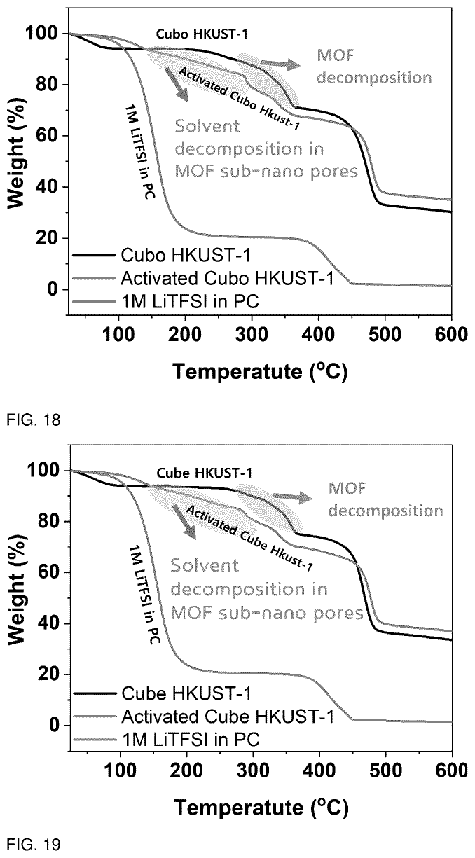

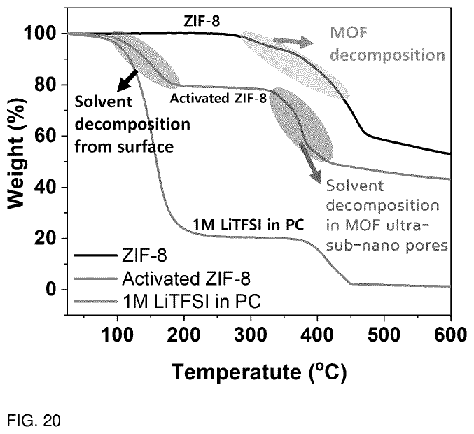

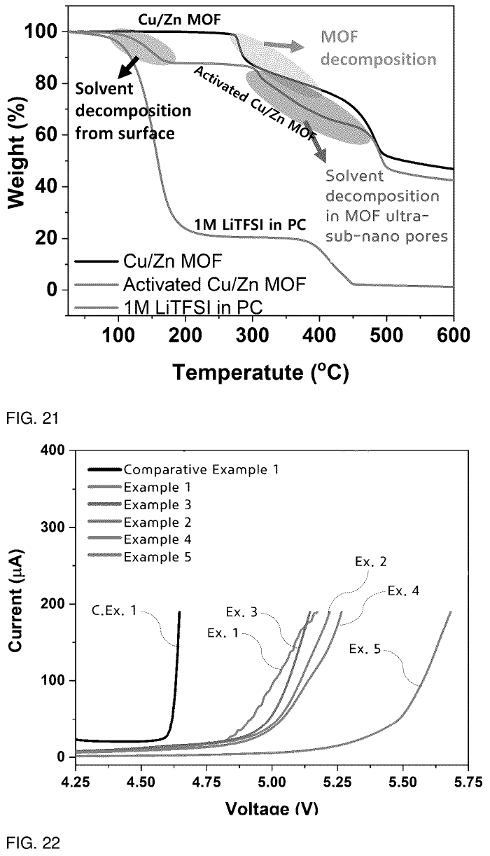

In order to verify the thermal stability of the manufactured semi-solid electrolyte membrane after activation, thermogravimetric analysis (TGA) was performed in the temperature range from room temperature to 600° C. on the pure liquid electrolyte (1 M LiTFSI in PC), the semi-solid electrolyte membrane according to each of Examples 1 to 5, and the MOF membrane before electrochemical activation used in the manufacturing process thereof, and the result of the Example 1 is shown in FIG. 17, the result of the Example 2 is shown in FIG. 18, the result of the Example 3 is shown in FIG. 19, the result of the Example 4 is shown in FIG. 20, the result of the Example 5 is shown in FIG. 21.

Referring to FIGS. 17 to 21, the MOF membrane before activation was observed to undergo thermal decomposition in the temperature range exceeding about 300° C., as represented in orange. In addition, the pure liquid electrolyte was observed to undergo primary thermal decomposition due to thermal decomposition of the PC solvent in the range of about 100° C. to 200° C., and secondary thermal decomposition due to thermal decomposition of the LiTFSI salt in the range of about 400° C. to 450° C., which are represented by the yellow and blue regions, respectively, in FIG. 17.

On the other hand, the semi-solid electrolyte membranes according to Examples 1 to 5 showed TGA curves of different shapes from the MOF membrane before activation and the pure liquid electrolyte. Specifically, referring to FIGS. 17 to 19 using the HKUST-1-based MOF, a gradual mass loss was observed in the range of about 150° C. to 300° C. This is deemed to be due to thermal decomposition of the liquid electrolyte located in the sub-nano pores in the MOF. Such results are confirmed to be much higher than the thermal decomposition temperature of a typical pure liquid electrolyte.

Also, referring to FIGS. 20 and 21 using the ZIF-8-based MOF, an initial mass loss was observed at a temperature of about 100° C. or higher, as represented in gray, which is deemed to be due to the liquid electrolyte remaining on the surface of the semi-solid electrolyte membrane. In addition, a second mass loss was observed in the range of about 300° C. to 500° C., as represented in purple, which is deemed to be due to thermal decomposition of the liquid electrolyte located in the ultra sub-nano pores in the MOF. These results show that the thermal stability is vastly superior due to the presence of the liquid electrolyte and the confinement of the liquid electrolyte in the pores in the MOF.

In general, the boiling point of the liquid electrolyte may decrease with an increase in the volume thereof, and thermal decomposition may occur easily with an increase in the temperature. On the other hand, the liquid electrolyte confined in the pores in the MOF had a higher thermal decomposition temperature than the pure liquid electrolyte, and in particular, the liquid electrolyte confined in the ultra sub-nano pores had a higher thermal decomposition temperature than the liquid electrolyte confined in the sub-nano pores and the pure liquid electrolyte, indicating vastly superior thermal stability.

This is because the liquid electrolyte confined in the ultra sub-nano pores is nearly equivalent to a closed structure, so a larger quantity of heat has to be applied to thermally decompose the same than when it has an open structure. Also, the liquid electrolyte confined in the sub-nano pores is expected to exhibit intermediate thermal stability because movement and adsorption of the LiTFSI salt and the PC solvent are free compared to the liquid electrolyte confined in the ultra sub-nano pores.

### Test Example 5—Electrochemical Characteristics of MOF-Based Electrolyte Membrane

In order to investigate the electrochemical characteristics of the semi-solid electrolyte membrane according to the present disclosure, a 2032 coin cell was manufactured by stacking the semi-solid electrolyte membrane according to each of Examples 1 to 5 and Comparative Example 1 between lithium metals, after which linear sweep voltammetry (LSV) was performed, and the results are shown in FIG. 22.

Referring to FIG. 22, the decomposition voltage of the semi-solid electrolyte membrane according to Example 5 was about 5.5 V and the decomposition voltage of the semi-solid electrolyte membranes according to Examples 1 to 4 was about 4.8 V to 5.0 V, whereas the decomposition voltage of the electrolyte membrane according to Comparative Example 1 was only about 4.6 V. Thus, it was confirmed that the electrochemical stability window of the semi-solid electrolyte membranes according to Examples 1 to 5 was very wide compared to the electrolyte membrane according to Comparative Example 1.

This is because the minimum energy required to decompose the liquid electrolyte confined in the pores in the MOF increases, and accordingly, it is possible to ensure stable driving of a battery with the semi-solid electrolyte membrane according to Example at a higher voltage.

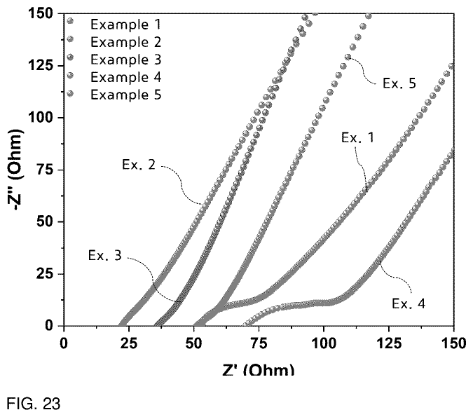

In addition, electrochemical impedance analysis (EIS) was performed on the semi-solid electrolyte membranes according to Examples 1 to 5, and the resulting Nyquist plots are shown in FIG. 23 and the specific numerical values are shown in Table 2 below.

TABLE 2

| Classification | Ionic conductivity (S/cm) |
|---|---|
| Example 1 | 3.05 × 10⁻⁵ |
| Example 2 | 1.05 × 10⁻⁴ |
| Example 3 | 6.06 × 10⁻⁵ |
| Example 4 | 3.65 × 10⁻⁵ |
| Example 5 | 4.18 × 10⁻⁵ |

Referring to the results of FIG. 23 and Table 2, Examples 1 to 3 using the HKUST-1-based MOF, particularly Example 2, exhibited superior ionic conductivity compared to Examples 4 and 5 using the ZIF-8-based MOF. This is deemed to be because the HKUST-1-based MOF exhibited overall greater porosity than the ZIF-8-based MOF and thus contained a larger amount of the liquid electrolyte. Also, as confirmed in FIG. 3, this is deemed to be because Example 2 using Cubo HKUST-1 as the HKUST-1-based MOF had a hierarchical pore structure including both relatively small sub-nano pores located on the {111} plane and relatively large sub-nano pores located on the {001} plane.

Moreover, when comparing Examples 4 and 5, Example 5 using Cu-doped ZIF-8 showed higher ionic conductivity. This is deemed to be because more unsaturated metal sites were formed due to Cu doping, which enhanced the chemical adsorption of the LiTFSI liquid electrolyte.

### Test Example 6—Ion Conduction Channel

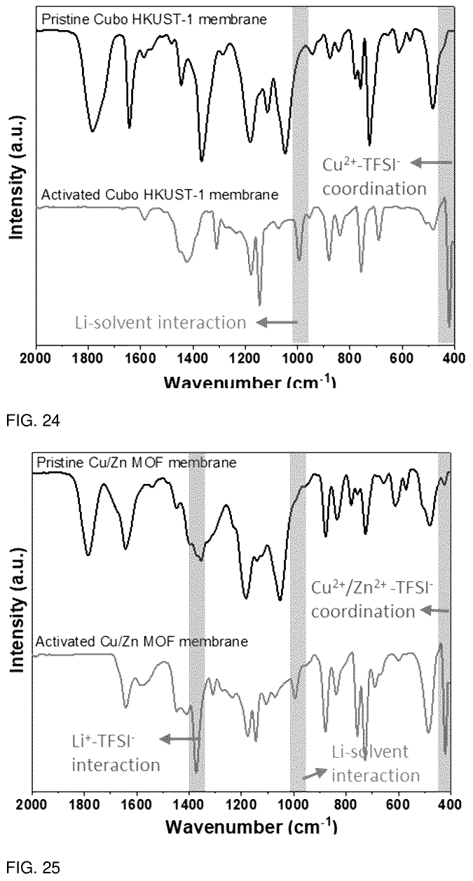

The chemical interaction of the LiTFSI liquid electrolyte (LE) in the MOF pores and the lithium ion transport kinetics in the MOF channels were investigated using attenuated total reflectance-Fourier transform infrared spectroscopy (ATR-FTIR). FIG. 24 shows results of ATR-FTIR of the MOF membrane before activation used in the process of manufacturing the semi-solid electrolyte membrane according to Example 2 and the semi-solid electrolyte membrane after activation.

FIG. 25 shows results of ATR-FTIR of the MOF membrane before activation used in the process of manufacturing the semi-solid electrolyte membrane according to Example 5 and the semi-solid electrolyte membrane after activation.

Referring to FIG. 24, peaks at about 422 cm⁻¹ and 996 cm⁻¹ were newly observed in the semi-solid electrolyte membrane after activation. The peak at about 422 cm⁻¹ is a superposition of the Cu—O lattice vibration and the stretching vibration of the S—N—S bond and is attributed to the interaction between the TFSI anion and the unsaturated Cu site, and the peak at about 996 cm⁻¹ is attributed to the interaction between the lithium cation and the PC solvent.

Referring to FIG. 25, peaks at about 421 cm⁻¹, 995 cm⁻¹, and about 1372 cm⁻¹ were newly observed in the semi-solid electrolyte membrane after activation. Similar to FIG. 24, the peak at about 421 cm⁻¹ is attributed to the interaction between the TFSI anion and the unsaturated Cu²⁺/Zn²⁺ site, and the peak at about 995 cm⁻¹ is attributed to the interaction between the lithium cation and the PC solvent. Additionally, the peak observed at about 1372 cm⁻¹ is attributed to the interaction between the TFSI anion and the lithium cation.

These results support the fact that the MOF having a wide pore distribution (sub-nano pores) as in Example 2 is configured such that the LiTFSI salt and the PC solvent easily penetrate the pores and thus has large lithium ion conduction channels as shown in the FIG. 4A, and lithium ions move along with the PC solvent in the large lithium ion conduction channels and are conducted similar to a typical liquid electrolyte. In addition, such results support the fact that the MOF having narrow channels formed by ultra sub-nano pores as in Example 5 has small lithium ion conduction channels as shown in the FIG. 4B, and lithium ions are conducted by a hopping mechanism in the small lithium ion conduction channels.

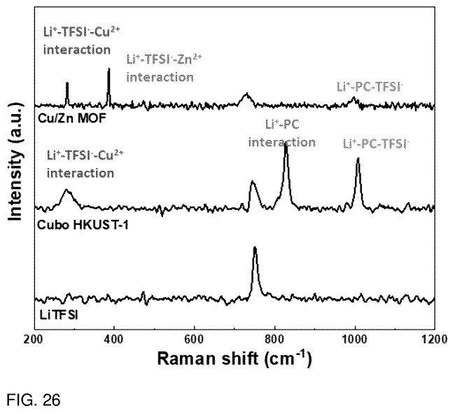

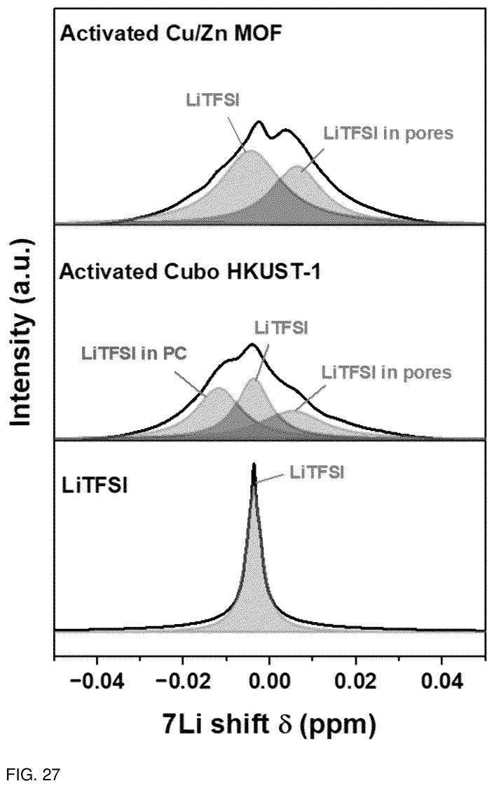

In addition, to more specifically investigate the two types of lithium ion conduction channels affected by the pore size distribution, Raman spectrum analysis was performed on the pure LIFTSI lithium salt and the semi-solid electrolyte membranes according to Examples 2 and 5, and the results are shown in FIG. 26. Also, ⁷Li solid-state MAS (magic angle spinning) NMR spectrum analysis was performed, and the results are shown in FIG. 27.

The results of FIGS. 24 to 27 show that the MOF having sub-nano pores has high lithium ion conductivity because the solvent and the lithium ions move directly under an electric field, but has low thermal stability and facilitates lithium dendrite growth compared to the MOF having ultra sub-nano pores. On the other hand, the MOF having ultra sub-nano pores has high thermal stability and is able to suppress lithium dendrite growth due to the presence of a smaller amount of solvent in the pores, but has low lithium ion conductivity because lithium ions move in a hopping manner.

### Test Example 7—Electrochemical Characteristics of Semi-Solid Electrolyte Membrane with Binary MOF

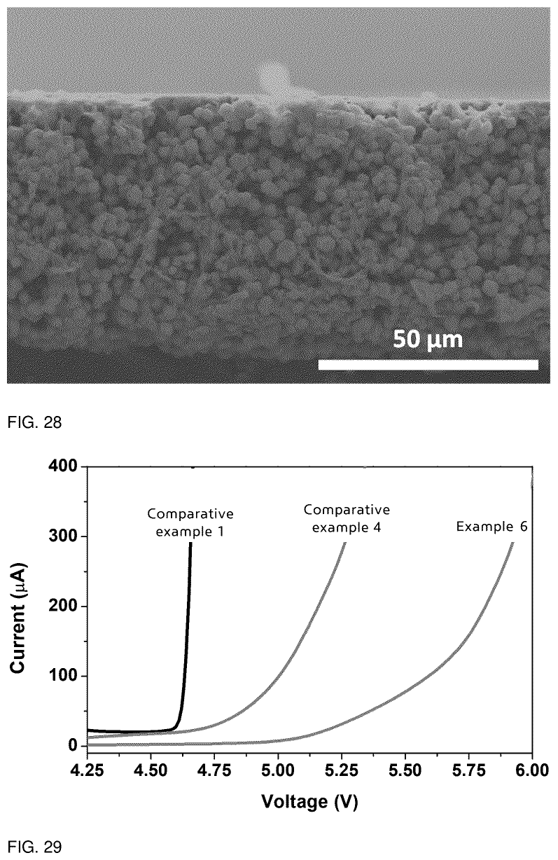

The semi-solid electrolyte membrane according to Example 6 was observed using SEM, and the results are shown in FIG. 28. Referring to FIG. 28, the semi-solid electrolyte membrane according to Example 6 was confirmed to be an electrolyte membrane with a thickness of about 60 μm having high density and uniformity.

In order to investigate the electrochemical characteristics of the semi-solid electrolyte membrane according to Example 6 using the mixture of MOF having sub-nano pores and MOF having ultra sub-nano pores, a 2032 coin cell was manufactured by stacking the semi-solid electrolyte membrane according to each of Example 6 and Comparative Examples 1 and 4 between lithium metals, after which LSV was performed, and the results are shown in FIG. 29.

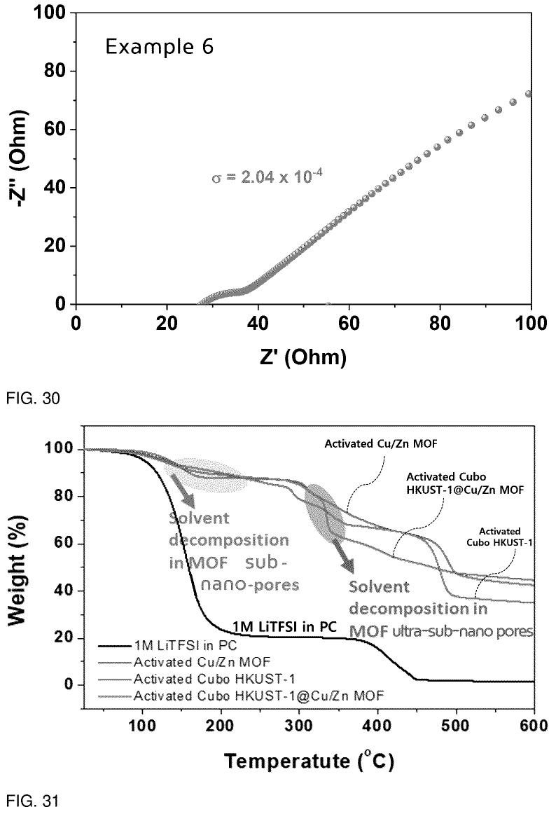

In addition, electrochemical impedance spectroscopy (EIS) was performed on the semi-solid electrolyte membrane according to Example 6, and the resulting Nyquist plot is shown in FIG. 30.

Referring to FIGS. 29 and 30, Example 6 using the binary MOF exhibited excellent electrochemical stability even at 5.25 V, which was regarded as vastly superior compared to the electrolyte membrane according to Comparative Example 1 and the semi-solid electrolyte membrane using the binary MOF before activation according to Comparative Example 4. Also, the ionic conductivity of Example 6 was measured to be about 2.04×10⁻⁴ S/cm, which was regarded as high compared to the semi-solid electrolyte membranes according to Examples 1 to 5 shown in Table 2. This is deemed to be because the binary MOF used in Example 6 had both large lithium ion conduction channels and small lithium ion conduction channels.

### Test Example 8—Thermal Stability of Semi-Solid Electrolyte Membrane with Binary MOF

In order to verify the thermal stability of the semi-solid electrolyte membrane with the binary MOF, thermogravimetric analysis (TGA) was performed in the temperature range from room temperature to 600° C. on the pure liquid electrolyte (1 M LiTFSI in PC), the semi-solid electrolyte membrane according to each of Examples 2, 5, and 6, and the MOF membrane before electrochemical activation used in the manufacturing process thereof, and the results are shown in FIG. 31.

Referring to the results of FIG. 31, in Example 6, the liquid electrolyte confined in the pores in the MOF (sub-nano) having a hierarchical pore structure was thermally decomposed in the temperature range of about 150° C. to 250° C., as represented by the light green region, and the liquid electrolyte confined in the pores in the MOF having ultra sub-nano pores was thermally decomposed at a temperature of about 350° C., as represented by the purple region.

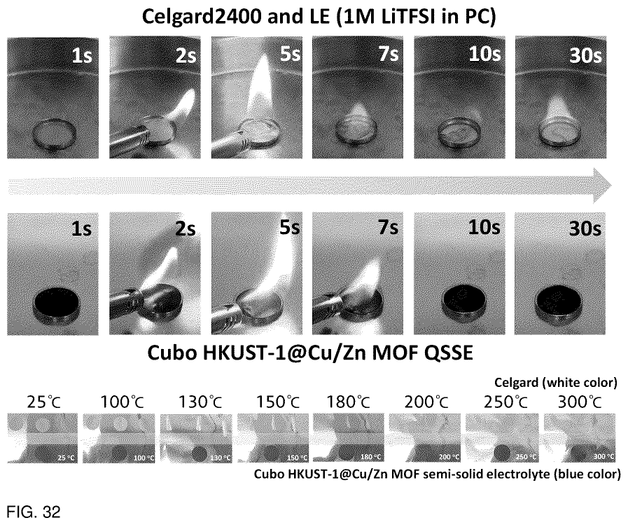

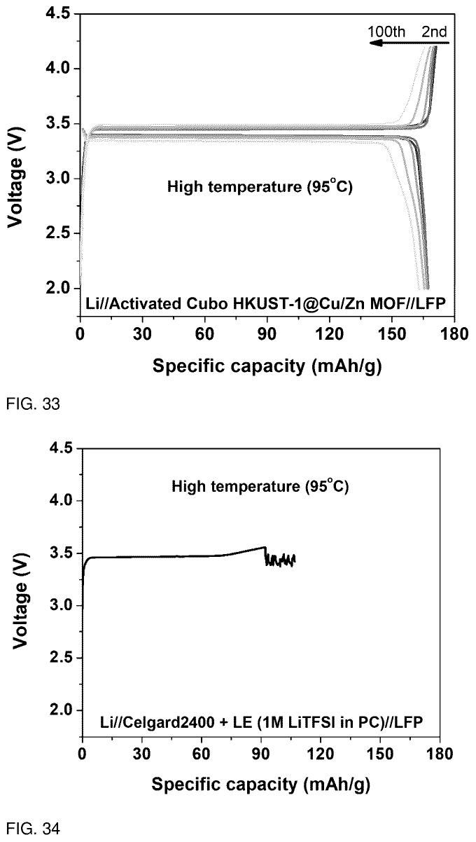

Also, whether the semi-solid electrolyte membranes according to Comparative Example 1 and Example 6 were exposed to fire and combusted was observed, and the results are shown in the top of FIG. 32. Also, the semi-solid electrolyte membrane according to each of Comparative Example 1 and Example 6 was placed on a hot plate, the temperature of the hot plate was elevated from room temperature at a rate of 5° C./min, the temperature was maintained at 100, 130, 150, 180, 200, 250, and 300° C. for 30 minutes, and the presence or absence of thermal shrinkage was observed. The results of heat shrinkage are shown in the bottom of FIG. 32.

Referring to FIG. 32, the semi-solid electrolyte membrane according to Example 6 was superior in both heat shrinkage resistance and heat resistance compared to the electrolyte membrane according to Comparative Example 1. Based on the results, the battery with the semi-solid electrolyte membrane according to Example 6 was capable of effectively preventing internal short circuit of the cell during driving at a high temperature.

### Test Example 9—High-Temperature Driving of Battery with Semi-Solid Electrolyte Membrane with Binary MOF

In order to investigate the high-temperature performance of the semi-solid electrolyte membrane with the binary MOF, a full cell was manufactured by attaching lithium metal to one side of the semi-solid electrolyte membrane according to Example 6 and attaching a cathode active material layer including LiFePO₄ as a cathode active material, carbon black as a conductive material, and PVdF as a binder and aluminum foil to the remaining side thereof. In addition, a full cell with the electrolyte membrane according to Comparative Example 1 was manufactured using the same method as above.

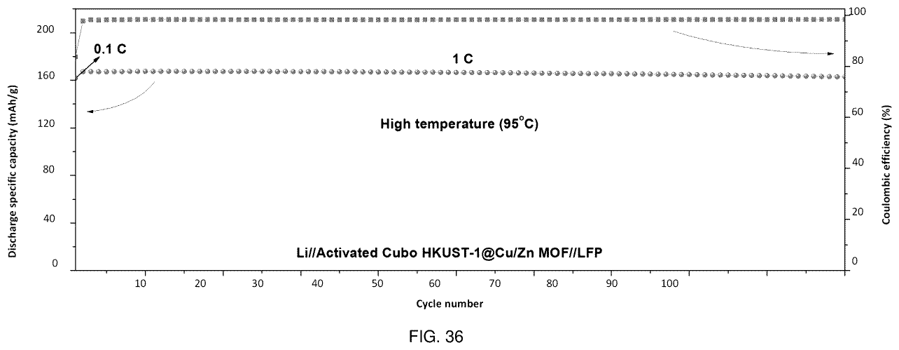

The full cell was subjected to a total of 100 cycles of charging and discharging at a 1 C rate at a high temperature of 95° C., and the charge/discharge curves during the process and the discharge capacity (Coulombic efficiency) depending on the number of cycles are shown in FIGS. 33 and 36, respectively. Referring to the results of FIGS. 33 and 36, 97% of the initial discharge capacity (162.8 mAh/g) was maintained even after 100 cycles of charging and discharging. These results are consistent with the results of Test Example 8 showing excellent thermal stability of the semi-solid electrolyte membrane according to Example 6.

On the other hand, referring to the results of FIG. 34, which is a galvanostatic charge-discharge (GCD) curve of the full cell with the semi-solid electrolyte membrane according to Comparative Example 1, cell failure occurred during the first cycle of charging and discharging. This is deemed to be due to an approach to the thermal decomposition point of the bulk liquid electrolyte at a high temperature of about 95° C., as can be confirmed from the results of thermogravimetric analysis for the semi-solid electrolyte membrane according to Comparative Example 1.

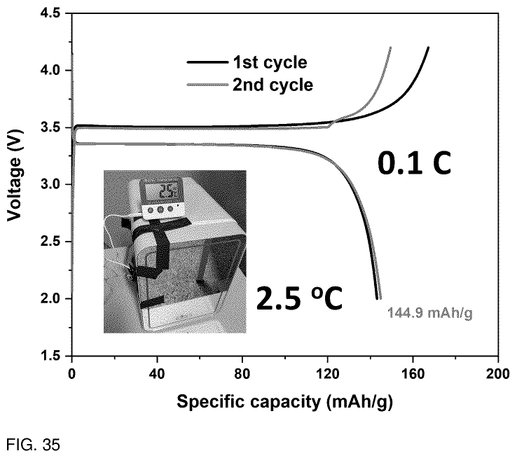

Also, in order to evaluate the low-temperature stability of the semi-solid electrolyte membrane according to Example 6, the full cell with the semi-solid electrolyte membrane according to Example 6 was subjected to a total of 2 cycles of charging and discharging at a 0.1 C rate at about 2.5° C., and the results are shown in FIG. 35. Referring to FIG. 35, the full cell with the semi-solid electrolyte membrane according to Example 6 exhibited a very high initial discharge capacity of 144.9 mAh/g even at a low temperature of 2.5° C.

Therefore, it was confirmed that the semi-solid electrolyte membrane with the binary MOF had excellent battery performance and durability even under extreme conditions (high and low temperatures).

As is apparent from the foregoing, a semi-solid electrolyte membrane according to the present disclosure includes a binary MOF having different pore structures and a liquid electrolyte, and thus can exhibit high ionic conductivity and stability.

Specifically, by introducing a binary MOF including a first MOF containing relatively large pores and a second MOF containing small pores, a semi-solid electrolyte membrane having excellent ionic conductivity and stability can be obtained.

According to the present disclosure, a semi-solid electrolyte membrane having excellent interfacial contact between an electrode and an electrolyte and a method of manufacturing the same are provided.

According to the present disclosure, a semi-solid electrolyte membrane having excellent thermal and electrochemical stability and a method of manufacturing the same are provided.

The effects of the present disclosure are not limited to the foregoing. It should be understood that the effects of the present disclosure include all effects that can be inferred from the description of the present disclosure.

As the embodiments of the present disclosure have been described above, those skilled in the art will appreciate that various modifications and alterations are possible through change, deletion or addition of components without departing from the scope and spirit of the present disclosure as described in the accompanying claims, which will also be said to be included within the scope of rights of the present disclosure.

What is claimed is:

1. A semi-solid electrolyte membrane for a lithium secondary battery, comprising:
a porous metal-organic framework (MOF); and
a liquid electrolyte containing a lithium salt and a non-aqueous organic solvent,
wherein the liquid electrolyte is contained in pores in the metal-organic framework.

2. The semi-solid electrolyte membrane of claim 1, wherein the metal-organic framework comprises any one selected from the group consisting of HKUST-1, ZIF-8, Cu/Zn MOF, and combinations thereof,
wherein the HKUST-1 comprises any one selected from the group consisting of Oct HKUST-1, Cubo HKUST-1, Cube HKUST-1, and combinations thereof.

3. The semi-solid electrolyte membrane of claim 1, wherein the metal-organic framework comprises a first MOF and a second MOF having different pore structures.

4. The semi-solid electrolyte membrane of claim 3, wherein the first MOF has a pore structure comprising sub-nano pores, and the second MOF has a pore structure comprising ultra sub-nano pores.

5. The semi-solid electrolyte membrane of claim 3, wherein the first MOF comprises any one selected from the group consisting of Oct HKUST-1, Cubo HKUST-1, Cube HKUST-1, and combinations thereof,
wherein the second MOF comprises any one selected from the group consisting of ZIF-8, Cu/Zn MOF, and combinations thereof.

6. The semi-solid electrolyte membrane of claim 3, wherein the first MOF comprises Cubo HKUST-1, and the second MOF comprises Cu/Zn MOF.

7. The semi-solid electrolyte membrane of claim 3, wherein a weight ratio of the first MOF to the second MOF is 1:0.5 to 1:2.

8. The semi-solid electrolyte membrane of claim 3, wherein the first MOF comprises a large lithium ion channel, and the second MOF comprises a small lithium ion channel.

9. The semi-solid electrolyte membrane of claim 1, wherein the lithium salt comprises lithium bis(trifluoromethanesulfonyl)imide (LiTFSI), and the non-aqueous organic solvent comprises propylene carbonate (PC).

10. The semi-solid electrolyte membrane of claim 1, further comprising a binder.

11. The semi-solid electrolyte membrane of claim 10, wherein a weight ratio of the metal-organic framework to the binder is 3:1 to 5:1.

12. A method of manufacturing a semi-solid electrolyte membrane for a lithium secondary battery, comprising:
preparing a slurry comprising a porous metal-organic framework (MOF) and a binder;
manufacturing a MOF film by applying the slurry onto a substrate followed by drying;
manufacturing a MOF membrane by separating the MOF film from the substrate followed by pressing; and
performing electrochemical activation in which a liquid electrolyte is located in pores in the MOF membrane.

13. The method of claim 12, wherein the metal-organic framework comprises any one selected from the group consisting of HKUST-1, ZIF-8, Cu/Zn MOF, and combinations thereof.

14. The method of claim 12, wherein the metal-organic framework comprises a first MOF and a second MOF having different pore structures.

15. The method of claim 14, wherein the first MOF has a pore structure comprising sub-nano pores, and the second MOF has a pore structure comprising ultra sub-nano pores.

16. The method of claim 14, wherein the first MOF comprises any one selected from the group consisting of Oct HKUST-1, Cubo HKUST-1, Cube HKUST-1, and combinations thereof,
wherein the first MOF comprises Cubo HKUST-1, and the second MOF comprises Cu/Zn MOF
wherein the second MOF comprises any one selected from the group consisting of ZIF-8, Cu/Zn MOF, and combinations thereof.

17. The method of claim 14, wherein a weight ratio of the first MOF to the second MOF is 1:0.5 to 1:2.

18. The method of claim 12, wherein performing the electrochemical activation comprises:
degassing the MOF membrane;
manufacturing a lithium symmetric cell using the MOF membrane and the liquid electrolyte as an electrolyte membrane;
activating the MOF membrane by driving the lithium symmetric cell; and
separating an activated MOF membrane from the lithium symmetric cell.

19. A lithium secondary battery, comprising:
an anode current collector;
an anode active material layer located on the anode current collector;
the semi-solid electrolyte membrane of claim 1;
a cathode active material layer located on the semi-solid electrolyte membrane; and
a cathode current collector located on the cathode active material layer.

20. The lithium secondary battery of claim 19, wherein the anode active material layer comprises lithium metal.
